(19) United States
(12) Patent Application Publication
(10) Pub. No.: US 2003/0174815 A1
(43) Pub. Date: Sep. 18, 2003

(54) Instant messaging for caller notification

(76) Inventors: Clifford Neil Didcock, Wantage (GB); Michael Geoffrey Andrew Wilson, London (GB)

Correspondence Address: Ryan, Mason & Lewis, LLP, 90 Forest Avenue, Locust Valley, NY, 11560, US

(21) Appl. No.: 10/323,108

(22) Filed: Dec. 19, 2002

(30) Foreign Application Priority Data
Mar. 14, 2002 (EP) 02251836.9

(51) Int. Cl. H04M 11/00

(52) U.S. Cl. 379/88.13

(57) ABSTRACT

There is disclosed a unified messaging system in which a subscriber is notified of an incoming telephone call by a unified messaging voice server using instant messaging.

### FIELD OF THE INVENTION

The present invention relates to a computer telephony integration (CTI) application server, and the notification to users of such a server of information concerning incoming telephone calls. The invention relates particularly, but not exclusively, to a unified messaging server.

### BACKGROUND TO THE INVENTION

Unified messaging systems, which are one example of a CTI application, integrate several different communication media such that users are able to retrieve and send messages confirming various media using a single interface. Typically, a unified messaging system integrates voice messaging systems with e-mail systems. Interfaces to the system provide for, for example, telephones and personal computers. An example of a unified messaging system is disclosed in U.S. Pat. No. 5,557,659.

A typical unified messaging system broadly provides an architecture in which at least one unified messaging voice server is provided as an interface, or voice gateway, between a PBX system and an e-mail system. A typical e-mail system includes at least one message store, a directory, at least one e-mail client, and a user administrator application.

To allow unified messaging systems to scale to support large deployments, a voice mail domain is created. The voice mail domain consists of one or more voice servers, which work together to exhibit the characteristics of a larger system. The voice mail servers preferably share unified messaging configuration data.

It has been a known feature of unified messaging systems to be able to provide subscribers of the unified messaging system with information concerning incoming telephone calls. In such a feature, a subscriber, typically accessing the unified messaging system using a computer, receives messages on the computer screen providing information about an incoming call to help in determining whether to accept or reject the call.

However, there is a problem with such a feature in that its implementation requires that subscribers register with all voice servers in a multi-voice server environment, or for a specific centralised notification server to be provided. A further problem is that dedicated software must be installed and running on all client systems.

Because of these drawbacks, this feature has to date had limited appeal in CTI systems such as unified messaging systems.

It is an aim of the present invention to provide an improved unified messaging system in which subscriber notification is simplified. In particular, the present invention seeks to facilitate the capability to provide subscriber notification without the need to create and distribute per client software, and thereby allow easy deployment.

### SUMMARY OF THE INVENTION

According to the present invention there is provided a method of notifying a subscriber of a computer telephony integration system of a telephone call, the computer telephony integration system including at least one voice server, the method comprising registering at least one voice server and the subscriber with an instant messaging service, wherein on receipt of a telephone call for the subscriber a voice server initiates an instant messaging session with the subscriber.

The instant messaging session may identify to the subscriber a characteristic of the telephone call. The characteristic of the telephone call may include one of the originating telephone numbers, or the identity of the caller.

Prior to initiating the instant messaging session the voice server may establish that the subscriber is available for an instant messaging session.

The voice server may send a message to the subscriber requesting the subscriber to identify how the call is to be handled.

In response to the instant message the subscriber may send a response to indicate whether to: accept the call, reject the call, or transmit a text message to the caller. The voice server may convert any such text message to speech.

The subscriber may provide the voice server with rules for handling incoming calls for that subscriber. The rules may apply to all incoming calls. The rules may apply to selected incoming calls. The rules may apply to calls from selected callers. The rules may apply to calls in selected time periods.

Further according to the present invention there is provided a computer telephony integration system including at least one voice server and a subscriber, wherein at least one voice server and the subscriber are registered with an instant messaging service, such that on receipt of a telephone call for the subscriber at least one voice server initiates an instant messaging session with the subscriber.

The computer telephony integration system may further include an instant messaging server.

In the computer telephony integration system the voice server is a unified messaging server.

There may further be provided a computer program product for storing computer program code for performing the defined method.

### BRIEF DESCRIPTION OF THE FIGURES

The invention will now be described by way of example with reference to the accompanying drawings, in which:

FIG. 1 illustrates the architecture of a known unified messaging system;

FIG. 2 illustrates the implementation of a unified messaging system according to the present invention;

FIG. 3 illustrates the sequence of actions accompanying the unified messaging system's use of instant messaging to notify the subscriber of a call; and

FIG. 4 illustrates the possible sequences of actions when the subscriber responds to a notification raised as in FIG. 3.

### DESCRIPTION OF THE PREFERRED EMBODIMENTS

The invention is now described herein with reference to an implementation in an exemplary unified messaging system. The invention, however, is not limited in its applicability to such an exemplary system. As set out in the introduction, the invention is applicable to any computer telephony integration system.

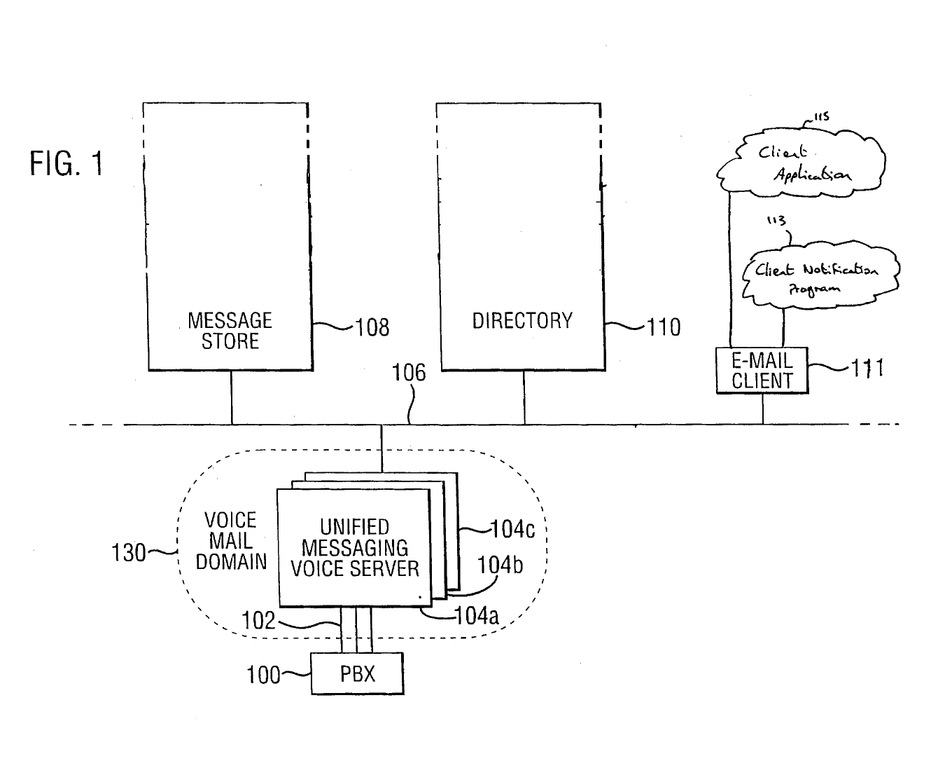

Referring to FIG. 1, there is illustrated the architecture of a typical unified messaging system. The system comprises one or more message stores 108, a directory 110, and at least one unified messaging voice server 104. In the example of FIG. 1, there is illustrated a set of three voice servers, 104a, 104b and 104c. It should be noted that the example of FIG. 1 is for illustration purposes only, and a system may be provided with more or less than three voice severs. Together, the set of three voice servers define a voice mail domain 130. In addition, at least one e-mail client 111 is also inter-connected. In practice many e-mail clients, or subscribers, will be connected in the system. It should further be noted that e-mail clients are illustrated for example purposes only, and other types of client may be connected in the system.

The three unified messaging voice servers 104a to 104c are connected via connections 102 to a PBX 100. The interconnection of the various elements shown in FIG. 1 is outside the scope of the present invention and is familiar to one skilled in the art. For ease of description herein, the various elements are shown as interconnected by a common network correction 106. However, in practice the various elements may not be connected on a common interface.

At least one message store 108, the directory 110, and at least one e-mail client 111 constitute the user e-mail system. It should be noted that the e-mail user system includes further elements, not shown in FIG. 1 but familiar to one skilled in the art. The introduction of the unified messaging voice sever 104, connected to the PBX 100, creates the unified messaging system. The unified messaging functionality introduced into the e-mail system integrates closely with the existing system structure. The unified messaging voice server 104 utilises the (e-mail) directory 110. The e-mail client 111 is typically a computer terminal.

The message store 108 stores messages (e-mail and voice) associated with system users, and the directory 110 stores descriptive attributes associated with those system users.

The unified messaging voice sever 104 is a gateway (a voice portal) into and out of the existing e-mail system.

As discussed in the background to the invention, a known CTI server or unified messaging product-class feature is the proposed ability for unified messaging subscribers to receive a ‘screen-pop’ type notification when a call is received for them. For this feature to operate, a specific unified messaging client notification program needs to exist and be registered and running on the subscriber's client computer. FIG. 1 shows such a client notification program 113 associated with the e-mail client 111. It is not essential that there be a direct association of the client notification program with an e-mail client, though many instant messaging applications maybe integrated with e-mail in some way.

The client notification program 113, when initiated, registers with all the unified messaging voice servers 104. As part of handling telephone calls for that subscriber or client, the unified messaging voice server communicates with a client application 115 running on the e-mail client, using a proprietary protocol, to convey caller information to the client. The caller information may, for example, be the caller's phone number or the reason for the call. The client application may then ‘pop-up’ a dialog box on the subscriber's computer informing the client of the call. The dialog box preferably invites the subscriber to accept the call, play a message for the caller, or reject the call, preferably with a default rejection after a timeout period. It should be noted that techniques other than a pop-up dialog box may be utilised, and such technique is described herein for example purposes only.

Such an application has not yet been implemented very successfully in a unified messaging system because of significant drawbacks associated with its implementation. One drawback is that the mechanism does not scale well for a multi-server voice domain as shown in FIG. 1, as the subscriber must register with all of the voice severs 104. Alternatively, some form of centralised notification server would have to be provided, which presents additional complexity and a single point of failure.

Another drawback is that additional unified messaging software needs to be present and running on all subscriber's computers. This makes deployment and acceptance of the solution considerably more challenging.

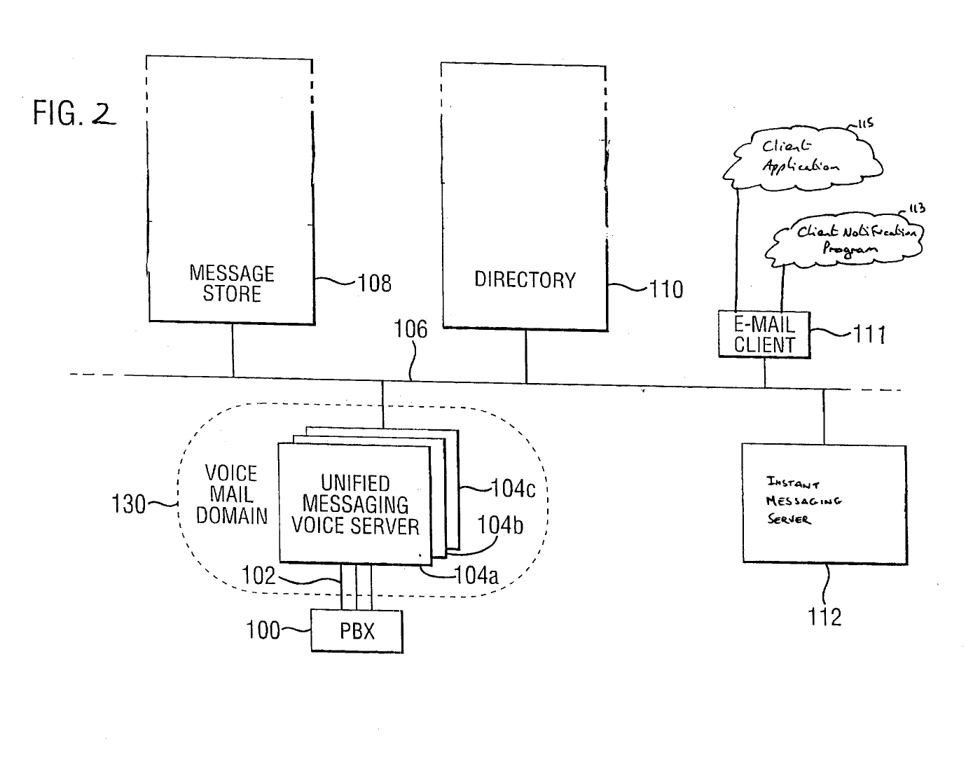

In accordance with the present invention, the exemplary unified messaging arrangement of FIG. 1 is modified as shown in FIG. 2. Like reference numerals are used in FIG. 2 to identify elements corresponding to elements shown in FIG. 1.

In accordance with the present invention an instant messaging service is introduced into the unified messaging network, as represented by the instant messaging server 112 in the example of FIG. 2. As shown in FIG. 2, the instant messaging server is introduced such that it is connected to the e-mail client 111 and the unified messaging voice servers 104, by connection on the line 106. The interconnection of the instant messaging server may be different in a practical application, but it is important that the instant messaging server communicates with the c-mail client 11 and the voice servers 104.

In practice the instant messaging server may already be provided via network connections, and certain clients, for example e-mail clients, may be registered with the instant messaging server to support known instant messaging applications.

In accordance with the present invention, each of the unified messaging voice servers 104 registers with the instant messaging server as an instant messaging client. Each of the subscribers 111 also register with the instant messaging server as an instant messaging client. It should be noted that in certain applications only selected clients, e.g., selected e-mail clients, may register with the instant messaging server. However all unified messaging voice server 104 must register to ensure that any client who chooses to register may utilise the present invention. When an e-mail client is involved in an instant messaging session, the IM server 112 acts as the IM client.

The type of instant messaging used is not important. It is merely required, for the invention to operate, that the subscriber and the voice servers register with the same type of instant messaging provider.

In accordance with the present invention, once registered the unified messaging voice servers may use instant messaging techniques to inform unified messaging subscribers of telephone calls. As such, standard communication mechanisms are used for this particular operation, thereby minimising the complexity of the implementation. As such the stated drawbacks of the previously known, but not widely implemented, solution are avoided.

Once the unified messaging voice servers and e-mail clients are registered with the instant messaging server, on receipt of a call the unified messaging voice server detects whether the e-mail client is on-line, in accordance with usual instant messaging techniques. If the client is on-line, the unified messaging voice server sends the call information to the subscriber in an IM (instant messaging) message. The subscriber's IM client then acts as the ‘screen-pop’ application, and the client can respond with a suitable message.

In an example scenario, one of the unified messaging voice servers 104 receives a telephone call originally destined for the e-mail client 111. On receipt of the telephone call, the unified messaging voice server retrieves the user configuration information for that client from the directory 110 in accordance with normal unified messaging techniques. The user configuration information contains information identifying that the user is configured with call-handling rules. Such rules, determined by the client, may be that all calls to that client should be handled by the unified messaging voice server; that calls should be handled by the unified messaging voice server after three rings; that calls should be handled by the unified messaging voice server if the client's phone is busy, etc.

In accordance with the present invention, one of the call handling/notification rules associated with the client identifies the client as an instant messaging user. The client may be identified as an instant messaging user at all times, or for certain time periods, or for telephone calls for certain people.

On determination of such information for a client, the unified messaging voice server acts as an instant messaging client and attempts to establish an instant messaging session with the subscriber. Assuming the client is available to the instant messaging service then the unified messaging service will use the instant messaging client application to initiate a chat with the subscriber.

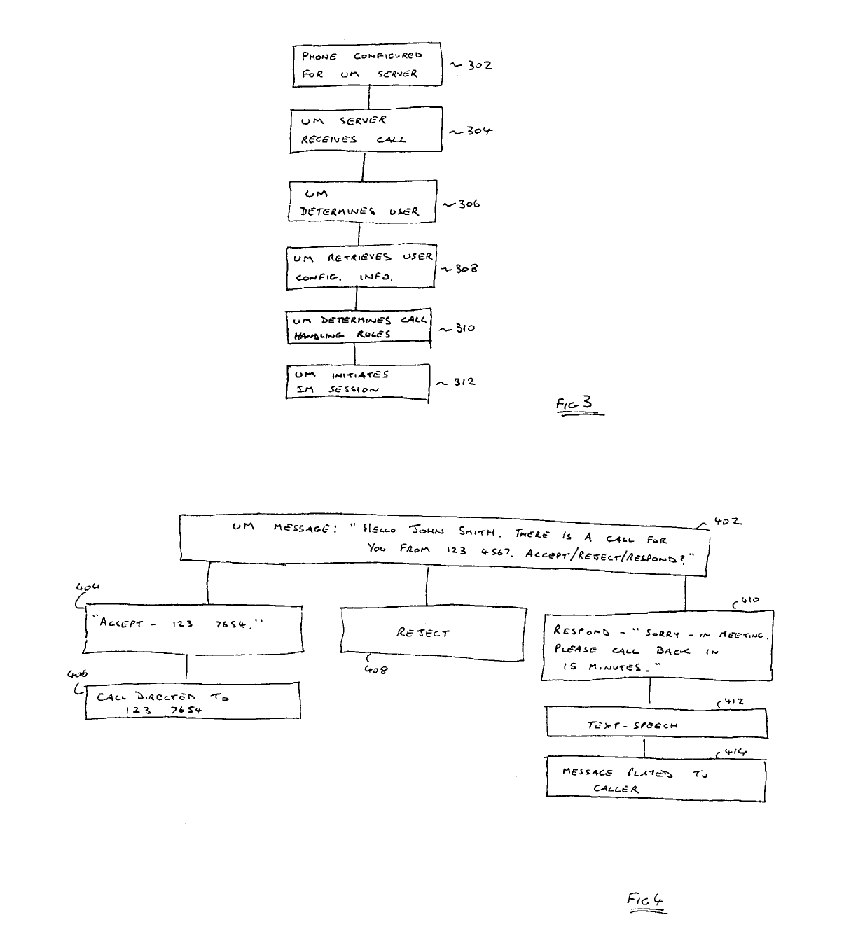

A specific example of the system of FIG. 2 in use is now illustrated with reference to the flow chart of FIG. 3.

In a first step, 302, a user is configured for unified messaging by registering with the unified messaging server. Any call to a user for which unified messaging is configured is first forwarded to the unified messaging server. As illustrated by step 304, the unified messaging server receives a call, and then in a step 306 determines the user associated with that call. The unified messaging server in a step 308 determines the user configuration information for that user, and consequently determines the call handling rules in step 310. Finally, in a step 312, the unified messaging server initiates an instant messaging session with the user.

A more specific example of the instant messaging exchange between the unified messaging server and the user is illustrated in FIG. 4. In a step 402 the instant messaging session is initiated by the unified messaging server, which for example sends a message to the user John Smith: “Hello John Smith. There is a call for you from 123 4567. Accept/Reject/Respond?” If the incoming number is recognised by caller ID, then the message may display the name of the caller rather than the caller's number. The content of the message is implementation dependent, and easily varied.

Responsive to the message, the user may take one of three actions. As a first action, the user may accept the call, in this example sending a message: “Accept—123 7654”, the user providing the unified messaging server the number of the telephone to which the call should be directed. Thereafter the unified messaging server, as illustrated by step 406, directs the call to number 123 7654.

As a possible second action, the user may reject the call in a step 308. The message may simply be “Reject”. In one example implementation, as a default action the call may automatically be rejected if the user does not respond to the message 402 within a certain time limit.

As a possible third action, the user may respond to the message from the unified messaging server, by providing a message to be relayed to the caller. For example, in step 410 the user may respond to the unified messaging server with “sorry—in meeting. Please call back in 15 minutes.” In a step 412 the unified messaging server 412 converts this text to speech, and in a step 414 plays the speech message to the caller.

Although the invention has been described herein with reference to a particular implementation in a unified messaging system, the applicability of the invention is more general. The invention more generally applies to any CTI application.

The skilled person will readily identify other possible implementations of the present invention beyond those given herein. The scope of the present invention is defined by the appended claims, and the skilled person will understand that modifications and variations to the invention as described herein are possible without departing from the scope of the invention as defined in the claims.

What is claimed is:

1. A method of notifying a subscriber of a computer telephony integration system of a telephone call, the computer telephony integration system including at least one voice server, the method comprising registering at least one voice server and the subscriber with an instant messaging service, wherein on receipt of a telephone call for the subscriber at least one voice server initiates an instant messaging session with the subscriber.

2. A method according to claim 1 wherein the instant messaging session identifies to the subscriber a characteristic of the telephone call.

3. A method according to claim 2 wherein the characteristic of the telephone call includes one of the originating telephone number, or the identity of the caller.

4. A method according to claim 1 wherein prior to initiating the instant messaging session the voice server establishes that the subscriber is available for an instant messaging session.

5. A method according to claim 1 wherein the voice server sends a message to the subscriber requesting the subscriber to identify how the call is to be handled.

6. A method according to claim 5 wherein in response to the message the subscriber sends a message to indicate whether to: accept the call, reject the call, or transmit a voice message to the caller.

7. A method according to claim 6 wherein the voice server converts any such voice message from text to speech.

8. A method according to claim 1 wherein the subscriber provides the voice server with rules for handling incoming calls for that subscriber.

9. A method according to claim 8 wherein the rules apply to all incoming calls.

10. A method according to claim 8 wherein the rules apply to selected incoming calls.

11. A method according to claim 10 wherein the rules apply to calls from selected callers.

12. A method according to claim 10 wherein the rules apply to calls in selected time periods.

13. A computer telephony integration system including at least one voice server and a subscriber, wherein at least one voice server and the subscriber are registered with an instant messaging service, such that on receipt of a telephone call for the subscriber at least one voice server initiates an instant messaging session with the subscriber.

14. A computer telephony integration system according to claim 13 further including an instant messaging server.

15. A computer telephony integration system according to claim 13 wherein the voice server is a unified messaging server.

16. A computer program product for storing computer program code for performing the method of claim 1.
